(19) United States
(12) Patent Application Publication
(10) Pub. No.: US 2011/0064460 A1
(43) Pub. Date: Mar. 17, 2011

(54) IMAGE FORMING APPARATUS AND IMAGE FORMING METHOD

(75) Inventors: Takeshi Watanabe, Kanagawa (JP); Daisuke Yamashita, Shizuoka (JP)

(73) Assignees: KABUSHIKI KAISHA TOSHIBA, Tokyo (JP); TOSHIBA TEC KABUSHIKI KAISHA, Tokyo (JP)

(21) Appl. No.: 12/859,582

(22) Filed: Aug. 19, 2010

Related U.S. Application Data
(60) Provisional application No. 61/242,999, filed on Sep. 16, 2009.

(51) Int. Cl. G03G 15/02

(52) U.S. Cl. 399/115

(57) ABSTRACT

An image forming apparatus includes an image carrier, a charging member which charges the image carrier and is arranged to provide an interval between itself and the image carrier, a power source to apply a voltage to the charging member, a measuring section to measure a voltage or a current between the image carrier and the charging member, and a gap adjustment section to adjust a gap between the image carrier and the charging member based on a measurement result of the voltage or the current.

### CROSS-REFERENCE TO RELATED APPLICATION

This application is based upon and claims the benefit of priority from the prior U.S. Patent Application 61/242,999 filed on Sep. 16, 2009, the entire contents of which are incorporated herein by reference.

### FIELD

The present invention relates to an image forming apparatus and an image forming method.

### BACKGROUND

In an electrophotographic image forming apparatus, the surface of a photoreceptor as an image carrier is charged, and an electrostatic latent image is formed by exposure. The electrostatic latent image is developed by supplying charged toner, and is transferred to a transfer medium such as paper.

As a method of charging the photoreceptor, corona charging, roller charging and brush charging are known. Among these, in a contact charging system in which a roller, a brush or the like is brought into contact with the photoreceptor to charge it, so-called ozoneless charging can be performed in which an ozone generation amount at the time of charging is smaller than that at the time of the corona charge. However, in the contact charging system, a fine powder, such as an external additive of toner, attached on the photoreceptor is liable to be attached to the charging unit, or the photoreceptor is worn away, and therefore, it is difficult to prolong the life.

Then, in recent years, attention is paid to non-contact roller charging in which a minute gap is provided relative to a photoreceptor and the photoreceptor is charged by discharge. However, in order to uniformly charge, it is necessary to control a gap between the photoreceptor and the charging roller to be several μm or less, and an influence is exerted by not only the straightness of the photoreceptor and the charging roller, but also the attachment accuracy and the shaved degree of each member.

Then, a method is used in which the diameters of both ends of a charging roller are increased to form a dumbbell shape, and both the ends are pressed to a coating surface of a photoreceptor. A specific gap can be provided between the photoreceptor and the charging roller by a step height between the center part and both the ends, and individual difference in film thickness of the photoreceptor can also be absorbed.

However, since both the ends of the charging roller contact with the coating surface, there arises a problem that the coating film of the photoreceptor at the contact portion or both the ends of the charging roller are shaved, or dust intervenes between these. Thus, even if the charging portion is in a usable state, they are obliged to be replaced, and it is difficult to prolong the life.

Then, a method is used in which light is irradiated to a gap between a charging roller and a photoreceptor, the transmitted light is measured, and the gap is adjusted. However, it is necessary to provide a light source, a sensor to detect the light and the like, and there is a problem that the image forming apparatus becomes complicated, and the cost becomes high.

### BRIEF DESCRIPTION OF THE DRAWINGS

The accompanying drawings, which are incorporated in and constitute a part of this specification, illustrates an embodiment of the invention and together with the description, serve to explain the principles of the invention.

FIGS. 1A, 1B, 2A, 2B, 3A and 3B are schematic views of an image forming apparatus according to an embodiment of the invention;

FIGS. 4 and 5 show a relation between a current value and a distance between a photoreceptor and a charging roller according to the embodiment of the invention;

FIG. 6 shows a structure of a four-drum tandem color printer according to the embodiment of the invention;

FIG. 7 shows a temporal change of a current value at the time of gap adjustment according to the embodiment of the invention;

FIGS. 8A to 8C show an operation state at the time of gap adjustment according to the embodiment of the invention;

FIG. 9 shows a charging roller according to the embodiment of the invention;

FIGS. 10 and 11 show an operation state at the time of gap adjustment according to the embodiment of the invention;

FIGS. 12A and 12B are views showing an image forming apparatus according to the embodiment of the invention.

### DETAILED DESCRIPTION

Reference will now be made in detail to the present embodiment of the invention, an example of which is illustrated in the accompanying drawing.

An image forming apparatus includes an image carrier, a charging member which charges the image carrier and is arranged to provide a gap between itself and the image carrier, a power source to apply a voltage to the charging member, a measuring section to measure a voltage or a current between the image carrier and the charging member, and the gap adjustment section to adjust a gap between the image carrier and the charging member based on a measurement result of the voltage or the current.

An image forming method according to an embodiment includes measuring a voltage or a current by applying a voltage between a charging member and a image carrier, the charging member to charge an image carrier and to be arranged to provide a gap between itself and the image carrier, adjusting the gap between the image carrier and the charging member based on a measurement result of the voltage or the current, charging the image carrier by the charging member, exposing the image carrier to form an electrostatic latent image, developing the electrostatic latent image to form an image on the image carrier, and transferring the image to a transfer medium.

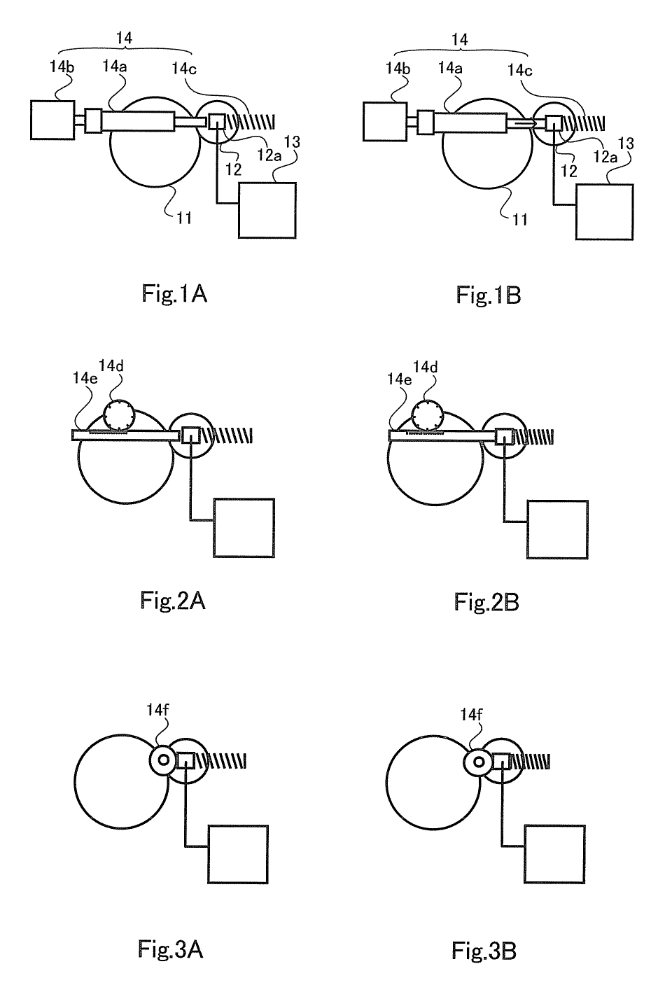

FIG. 1A shows an example of a partial structural view of an image forming apparatus. A photoreceptor 11 as an image carrier and a charging roller 12 as a charging member to charge the photoreceptor are arranged to be adjacent to each other. A power source 13 having a measuring section to measure a voltage and a current is connected to the charging roller 12.

A bearing 12a is provided at both ends of a shaft passing through the charging roller 12. The bearing 12a is connected to a gap control section 14 which moves the bearing 12a in a direction of separating from the photoreceptor 11 and adjusts a gap. In the gap control section 14, a micrometer 14a as a movement control section, a motor 14b to control a movement amount, and a spring 14c as an elastic body to press the bearing 12a to the photoreceptor 11 side are connected.

In the image forming apparatus as stated above, as the photoreceptor 11 as an image carrier, a well-known photoreceptor, for example, a plus-charged or minus-charged OPO (Organic Photoconductor) having chain polymerization functional group, or amorphous silicon is used.

As the charging roller 12 which is the charging member to charge the photoreceptor 11 as the image carrier, a semiconductive resin or rubber can be used. Not only a roller shape but also a block shape can also be used. It is preferable that the volume resistivity is 10⁴ to 10⁸ Ωcm. In view of mechanical accuracy, a resin material is preferable. More preferably, an ion conductive resin, for example, polyamide mixed with ABS resin or polypropylene resin is used.

As the charging member, in view of reduction of damage to the photoreceptor, it is preferable to use an elastic roller. JIS-A hardness thereof is 50° or more, and is more preferably 60 to 90°. When too soft, it is difficult to raise the accuracy, and further, a change in current value is large in the state where the charging member is in contact with the photoreceptor, and it is difficult to estimate the gap. On the other hand, when too hard, the effect of reduction of damage to the photoreceptor is reduced. When the hardness is within this range, and when the dispersion property of a conductive agent is excellent, the material is not particularly limited. When there is no irregularity and the straightness is high, it is preferable that the hardness is higher.

As described later, when the charging roller 12 as stated above is temporarily brought into contact at the time of measurement of voltage and current, it is preferable that a roller part larger than the diameter of an image area part is provided at both ends outside the image area part (center part). By such a structure, the image area part can be put in a non-contact state at the time of bringing into contact.

The charging roller 12 is attached to, for example, a shaft, and is supported by the bearing 12a provided at both ends of the shaft.

The power source 13 connected to the charging roller 12 as the charging member is provided in order to apply a voltage at the time of image formation and at the time of gap adjustment described later between the photoreceptor 11 as the image carrier and the charging roller 12 as the charging member. The power source 13 can apply a voltage of alternating current or alternating current superimposed on direct current to the charging roller 12 as the charging member. The voltage or current applied to the photoreceptor 11 as the image carrier is measured by a measuring section provided in the power source 13 or provided independently.

Incidentally, at the time of voltage application, the current may be measured while the voltage is made constant, or the voltage may be measured while the current is made constant. Besides, both are not made constant but may be changed, and a change in relation between the voltage and the current is detected and may be converted.

The gap adjustment section 14 moves the bearing 12a of the charging roller 12 in order to adjust the gap between the photoreceptor 11 as the image carrier and the charging roller 12 as the charging member based on the measured value of voltage or current. In FIG. 1A, the motor 14b is controlled to extend the micrometer 14a, and as shown in FIG. 1B, the bearing 12a is moved in the right direction, and the photoreceptor 11 and the charging roller 12 are separated from each other.

As the movement control section of the gap adjustment section 14, in addition to the micrometer, as shown in FIG. 2A showing a contact state and FIG. 2B showing a separate state, gears 14d and 14e can be used. Further, as shown in FIG. 3A showing a contact state and FIG. 3B showing a separate state, a cam 14f can be used.

The spring 14c as an elastic body is provided in order to press the bearing 12a to the photoreceptor 11 side. As the elastic body, a well-known elastic body such as, for example, a coil spring or a plate spring, can be used. Besides, no limitation is made to the spring, and an elastic body such as rubber can also be used.

In the image forming apparatus as stated above, for example, at the time of preparation operation of the image forming apparatus, when the environment is changed, or at the time of replacement of the photoreceptor, the gap between the photoreceptor 11 as the image carrier and the charging roller 12 as the charging member is adjusted.

As the initial state, as shown in FIG. 1B, the charging roller 12 is brought into contact with the photoreceptor 11 by the pressure of the spring 14c. Then, the power source 13 applies, for example, a voltage of alternating current superimposed on direct current to the charging roller 12, and the current value is measured. Thereafter, the micrometer 14a is controlled by the motor 14b of the movement control section 14, and the bearing 12a of the charging roller 12 is moved. While the charging roller 12 and the photoreceptor 11 are gradually separated from each other, a voltage is applied to the charging roller 12 similarly to the initial state, and the current value is measured.

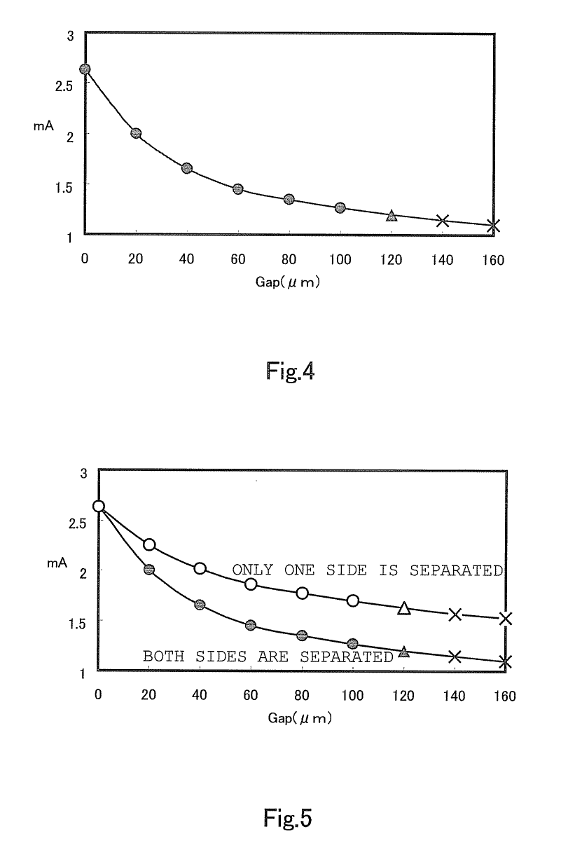

FIG. 4 shows an example of a relation between the current value measured as described above and the distance between the photoreceptor and the charging roller (AC voltage value: 2.3 kV). In FIG. 4, denotes a state where excellent and uniformity charging can be performed, Δ denotes a state where irregular charging occurs, and x denotes a state where stable discharge can not be performed. As shown in FIG. 4, it is understood that the distance between the photoreceptor and the charging roller depends on the current value. When the current value becomes less than 1.3 mA, that is, when the distance between the photoreceptor and the charging roller exceeds 100 μm, stable discharge can not be performed, and a defective image is formed.

Incidentally, the reason why the charging roller 12 is brought into contact with the photoreceptor 11 is that the impedance of the charging roller 12, the electrostatic capacity of the photoreceptor 11 or the like is changed according to a use state, and the initial value (current value at a distance of 0) is changed. Accordingly, when a material the initial value of which is not changed can be used, it is not necessary to measure the initial value.

As described above, the distance between the photoreceptor and the charging roller depends on the current value, and the distance can be estimated by measuring the current or voltage. Accordingly, while the current value is measured, the charging roller is moved to obtain such a distance that stable discharge can be performed.

At this time, in order to separate both ends of the charging roller 12 simultaneously by the same distance from the photoreceptor 11 at high accuracy, a complicated section is required. Thus, it is preferable that for example, only one side of the charging roller 12 is gradually separated, and the separation is stopped when the current value becomes a reference value. Next, the opposite side is gradually separated, and the separation is stopped when the current value becomes the reference value at which the same distance as that at the one side is obtained.

FIG. 5 shows an example of a relation between the distance between the photoreceptor and the charging roller and the current value when only one side is separated. In FIG. 5, O denotes a state where excellent uniform charging is performed, Δ denotes a state where irregular charging is performed, and x denotes a state where stable discharge can not be performed. A case where both sides are separated is also shown. As shown in FIG. 5, although the change amount of current with respect to the distance becomes small as compared with the case where both sides are separated, it is understood that the distance between the photoreceptor and the charging roller depends on the current value, and has such a level that it can be sufficiently detected.

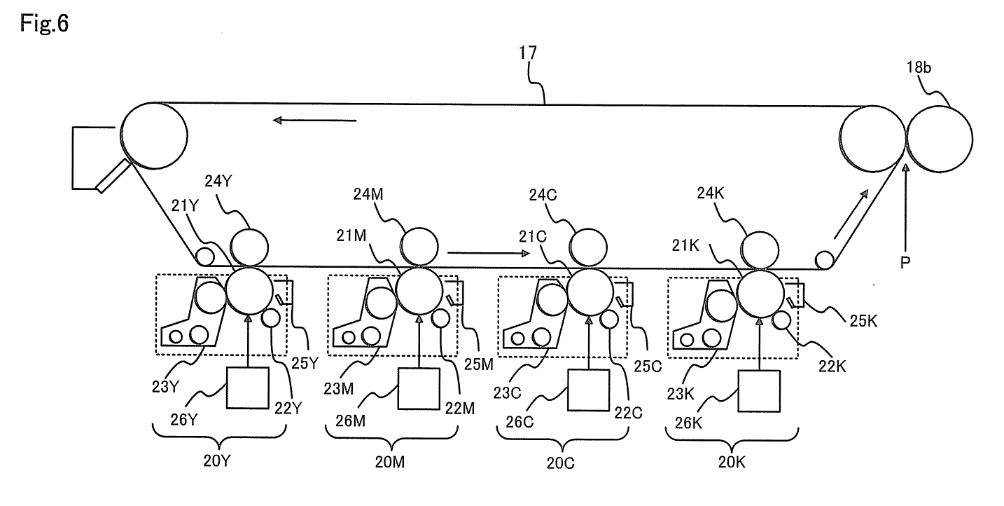

Incidentally, the structure as stated above can also be applied to a four-drum tandem color printer as shown in FIG. 6. As shown in FIG. 6, a secondary transfer roller 18b for transferring an image on an intermediate transfer belt 17 onto a transfer medium P and image forming units 20Y, 20M, 20C and 20K are arranged along the conveyance direction (arrow direction) of the intermediate transfer belt 17.

The image forming units 20Y, 20M, 20C and 20K respectively includes photoreceptors 21Y, 21M, 21C and 21K as image carriers. Further, charging devices 22Y, 22M, 22C and 22K having charging members as charging units and gap adjustment sections, developing devices 23Y, 23M, 23 and 23K having developing rollers as developing members and containing developers made of respective color toner particles of yellow, magenta, cyan and black and carrier particles, primary transfer rollers 24Y, 24M, 24C and 24K as transfer units, and cleaner units 25Y, 25M, 25C and 25K are respectively provided around the respective photoreceptors. These are arranged along the rotation direction of the corresponding photoreceptors 21Y, 21M, 21C and 21K.

The respective primary transfer rollers 24Y, 24M, 24C and 24K are arranged inside the intermediate transfer belt 10, and nip the intermediate transfer belt 17 in cooperation with the corresponding photoreceptors 21Y, 21M, 21C and 21K. Exposure devices 26Y, 26M, 26C and 26K are respectively arranged so that exposure points are formed on the outer peripheral surfaces of the photoreceptors 21Y, 21M, 21C and 21K between the charging devices 22Y, 22M, 22C and 22K and the developing devices 23Y, 23M, 23C and 23K. The secondary transfer roller 18b is arranged outside the intermediate transfer belt 17 so as to contact therewith.

In the image forming apparatus constructed as stated above, first, a toner image is formed by the image forming unit 20Y. In synchronization with the timing of the toner image formation in the image forming unit 20Y, the same process is performed also in the image forming units 20M, 20C and 20K. The toner images of magenta, cyan and black formed on the photoreceptors of the image forming units 20M, 20C and 20K are also successively primarily transferred onto the intermediate transfer belt 17.

The transfer medium P is conveyed from a cassette (not shown), and is sent to the intermediate transfer belt 17 by an aligning roller (not shown) in synchronization with the toner image on the intermediate transfer belt 17.

A bias (+) of reverse polarity to the charging polarity of the toner is applied to the secondary transfer roller 18b by a power source (not shown). As a result, the toner image on the intermediate transfer belt 17 is transferred onto the transfer medium P by a transfer electric field formed between the intermediate transfer belt 17 and the secondary transfer roller 18b. A fixing device (not shown) for fixing the toner transferred on the transfer medium P is arranged, and a fixed image is obtained by causing the transfer medium P to pass through the fixing device.

Incidentally, although the description is made on the example in which the image forming units are arranged in color order of yellow, magenta, cyan and black, the color order is not particularly limited. Besides, the embodiment can also be applied to a monochrome printer.

### Embodiment 1

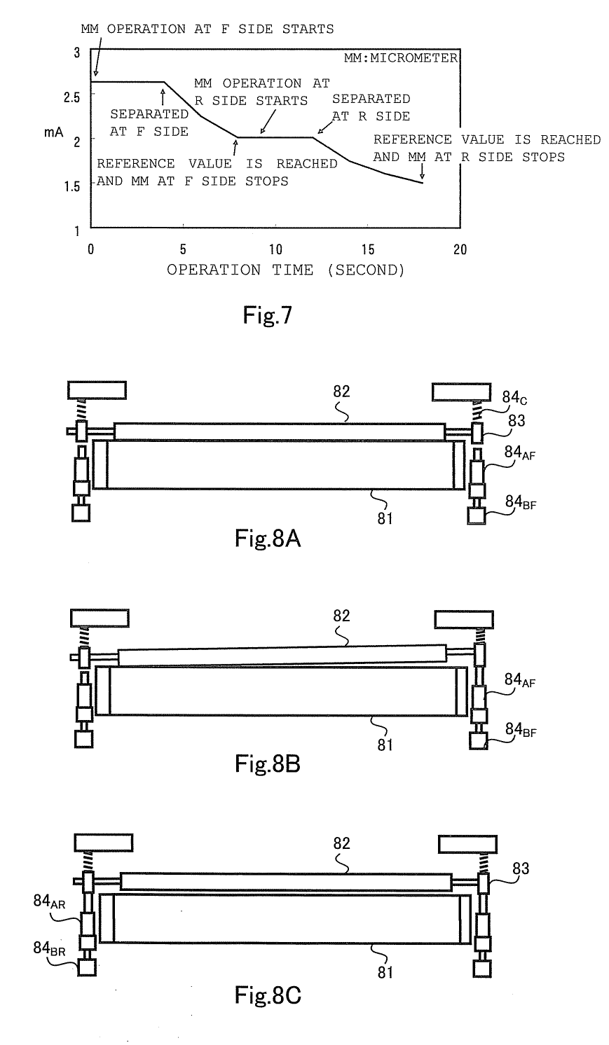

An image forming apparatus having the same structure as that of FIG. 1 is used, and a gap between a photoreceptor and a charging roller is adjusted at the time of preparation operation. As a charging roller, a polypropylene resin base ion conductive roller (volume resistivity of 2×10⁶ Ωcm) is used. FIG. 7 shows a temporal change of a current value at the time of gap adjustment, and FIGS. 8A to 8C show operation states at the time of gap adjustment.

As the initial state, as shown in FIG. 8A, a charging roller 82 is brought into contact with a photoreceptor 81 by pressure of a spring 84c. A power source applies a voltage of, for example, alternating current (pp 2.3 kV, 1.2 kHz) superimposed on direct current (DC-500V) to the charging roller 82, and a current value (2.6 mA) is measured by a measuring device incorporated in the power source.

After the initial state is measured, a micrometer 84AF is driven by a motor 84BF. As shown in FIG. 8B, while only the front side of the charging roller 82 is gradually separated from the photoreceptor 81, a superimposed voltage is applied similarly to the initial state, and a current value is measured. An allowance is provided between the micrometer 84AF and a bearing 84B, the charging roller 82 is not separated for a while after driving, and a current value is not changed. When the allowance portion disappears, the front side of the charging roller 82 is actually separated. The current value is abruptly lowered, and when the current value becomes 75% of that in the initial state, the micrometer 84AF is stopped. Incidentally, the stop condition is obtained from the correlation between the current value and the gap value (distance between the photoreceptor and the charging roller) shown in FIG. 5 and the like and from the current value at which an appropriate distance is obtained.

Subsequently, a micrometer 84AR is driven by a motor 84BR, and as shown in FIG. 8C, while only the rear side of the charging roller 82 is gradually separated from the photoreceptor 81, a superimposed voltage is applied similarly to the initial state, and a current value is measured. Similarly to the front side, when the charging roller is separated, the current value is abruptly lowered, and when the current value becomes 60% of the initial state, the micrometer 84AR is stopped. Incidentally, the stop condition is obtained similarly to the front side.

After the gap adjustment is performed in this way, actual image formation is performed.

As stated above, the separation operation is individually performed at both ends of the charging roller 82, and the gap adjustment is performed. Thus, when the micrometers 84AF and 84AR are respectively driven, the point when the charging roller 82 is separated at each end becomes clear.

Accordingly, the gap between the charging roller and the photoreceptor can be controlled at high accuracy, uniform charging to the photoreceptor becomes possible, and an excellent image can be formed. Besides, since the charging roller contacts only when it is brought into contact with the photoreceptor, the occurrence of shaving of the charging roller or the like is suppressed, and the life thereof can be prolonged.

In order to simultaneously separate both ends of the charging roller 82, it is necessary to perform movement control at an accuracy of 10 μm or less. This is because, even if the detected current value is normal, when one end is excessively separated and the other end is excessively close, uniform charging can not be performed, and accordingly, there is a possibility that erroneous determination is made. It is difficult to construct such a high accuracy mechanism at low cost.

However, according to this embodiment, since the charging roller 82 is moved one end by one end, the gap adjustment can be performed to enable uniform charging without providing a high accuracy mechanism.

In this embodiment, although the reference current value for stopping the driving of the micrometer is 60% of the initial state, it may be changed according to the use environment, and the use history and life state of the charging roller. For example, in the ion conductive material, the impedance of the roller is changed according to the use environment, and the impedance becomes high under a low temperature and low humidity environment. In such a case, in order to prevent an applied voltage from rising, the gap is set to be slightly narrow, and the reference current value is set to be rather high, for example, 70% of the initial value.

Besides, although the applied voltage at the time of gap adjustment is such that alternating current (pp 2.3 kV, 1.2 kHz) is superimposed on direct current (DC-500V), the voltage is set to be higher than that at the time of actual image formation (alternating current (pp 2.0 kV, 1.2 kHz) is superimposed). Although these may be the same value, when the applied voltage is set to be high, the detection accuracy can be improved. When the voltage (bias) applied to the charging roller is high, there is a tendency that damage given to the photoreceptor becomes high. However, the application is performed for a short time at the time of gap adjustment or the like, and the influence on the photoreceptor is suppressed.

The applied voltage at the time of gap adjustment may also be changed according to the use environment, and the use history and life state of the charging roller. When the impedance of the charging roller becomes high, the detection accuracy can be raised when the applied voltage is made high.

### Embodiment 2

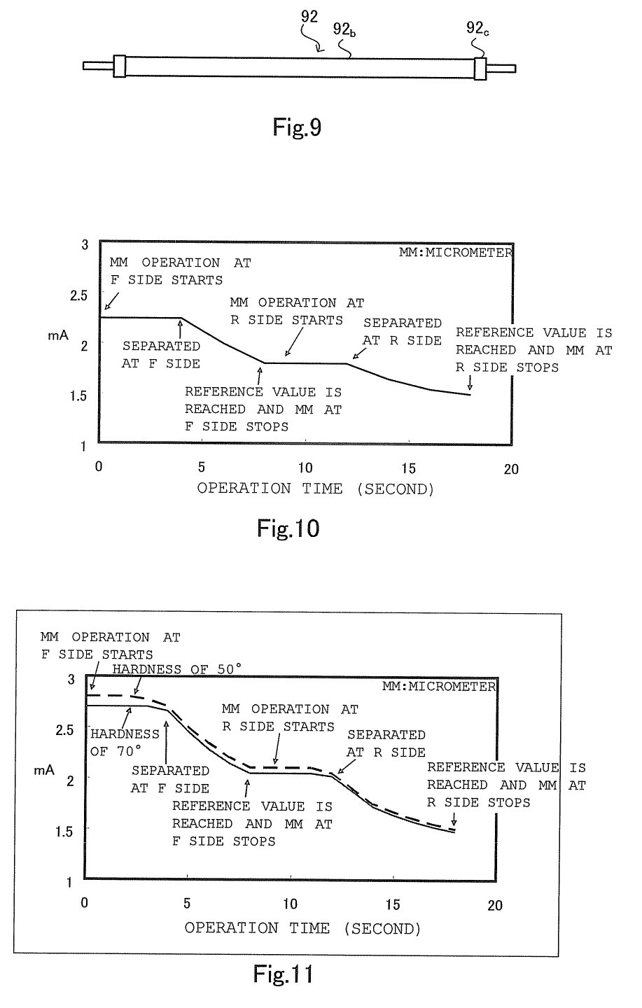

An image forming apparatus having the same structure as that of FIG. 1 is used, and a gap between a photoreceptor and a charging roller is adjusted at the time of preparation operation. As the charging roller, the same material as that of embodiment 1 is used, and as shown in FIG. 9, a roller part 92c having a diameter larger than the diameter of an image area part 92b is provided at both ends outside the image area part (center part) 92b. A step height between the roller part 92c and the image area part 92b is 20 μm.

The charging roller 92 is brought into contact with a photoreceptor 91 at the roller part 92c, and similarly to embodiment 1, the same voltage (alternating current (pp 2.3 kV, 1.2 kHz) is superimposed on direct current (DC-500V)) is applied to measure a current value. The front side and the rear side of the charging roller 92 are successively separated, and gap adjustment is performed.

After the gap adjustment is performed in this way, actual image formation is performed.

FIG. 10 shows a temporal change of the current value at the time of gap adjustment. In the initial state (at the time of bringing into contact), the gap between the image area part 92b and the photoreceptor 91 is 20 μm by the step height relative to the roller part 92c. Accordingly, even if the same voltage as that of embodiment 1 is applied, the current value is about 2.2 mA and is lower than the current value (2.6 mA) in the initial state of embodiment 1, and the change amount (sensitivity) of the current value is slightly lowered. However, the same behavior as that of embodiment is indicated.

As described above, since the inclination of the change of the current value becomes small by providing the roller part 92c on the charging roller 92, the detection sensitivity of the gap between the photoreceptor and the charging roller becomes slightly low. However, when the photoreceptor 91 and the charging roller 92 are brought into contact with each other at the time of gap adjustment, the image area part 92b can be put in a non-contact state. Accordingly, similarly to embodiment 1, uniform charging to the photoreceptor becomes possible, and an excellent image can be formed. Further, damage to the photoreceptor and the image area of the charging roller is more reduced, which enables the reliability to be improved and the life to be prolonged.

In this embodiment, although the step height between the image area part 92b and the roller part 92c is made 20 μm, a detectable sensitivity has only to be provided. For example, when the optimum range of the gap between the photoreceptor and the charging roller is up to about 100 μm, it is preferable that the step height is 10 to 50 μm. When the step height is larger than 50 μm, it becomes difficult to obtain a sufficient detection sensitivity. On the other hand, when the step height is less than 10 μm, unless the straightness of the roller and the photoreceptor is made high, both contacts with each other. When actual accuracy is considered, the step height is more preferably 15 to 30 μm.

### Embodiment 3

An image forming apparatus having the same structure as that of FIG. 1 is used, and a gap between a photoreceptor and a charging roller is adjusted at the time of preparation operation. As a charging roller, not the resin roller used in embodiments 1 and 2, but an elastic roller is used. As the elastic roller, CR (polychloroprene) rubber rollers having JIS-A hardness of 50° and 70° are used.

Similarly to embodiment 1, the charging roller is brought into contact with the photoreceptor, and the same voltage (alternating current (pp 2.3 kV, 1.2 kHz) is superimposed on direct current (DC-500 V)) is applied to measure a current value. The front side and the rear side of the charging roller are successively separated, and gap adjustment is performed.

After the gap adjustment is performed in this way, actual image formation is performed.

FIG. 11 shows a temporal change of the current value at the time of gap adjustment. Incidentally, a solid line indicates a value when the charging roller having JIS-A hardness of 70° is used, and a broken line indicates a value when the charging roller having JIS-A hardness of 50° is used.

In both the charging rollers, the current value is gradually decreased in the state of contact with the photoreceptor, however, the charging roller having a hardness of 50° has a larger reduction amount. This is because when the hardness of the charging roller is low, a nip width (contact area) relative to the photoreceptor is significantly changed even in the contact state, and consequently, the current value is significantly changed.

In both the charging rollers, the front side of the charging roller is separated from the photoreceptor after about 4 seconds. However, in the charging roller having a hardness of 70°, the timing of separation can be easily determined from the change of the reduction amount of the current value. On the other hand, in the charging roller having a hardness of 50°, the change of the reduction amount of the current value at the time of separation is small, and the determination of timing of separation is rather difficult. Accordingly, in the charging roller having a hardness of 50°, as compared with the charging roller having a hardness of 70°, the accuracy of estimating the actual gap is reduced.

As stated above, by using the elastic roller, especially in the charging roller having a hardness of 50°, the change of the reduction amount of the current value at the time of separation becomes low, and the temporal change of the current value at the time of gap adjustment becomes slightly smooth. However, damage when the photoreceptor and the charging roller are brought into contact with each other at the time of gap adjustment can be prevented.

Accordingly, similarly to embodiment 1, uniform charging to the photoreceptor becomes possible, and an excellent image can be formed. Further, damage of the photoreceptor and the charging roller is more reduced, which enables the reliability to be improved and the life to be prolonged.

According to the structures of the embodiments, since the charging roller contacts with the photoreceptor only at the time of bringing into contact, the charging roller is not worn away. Accordingly, when toner or external additive sputtered from the photoreceptor to the charging roller are cleaned, the charging roller can be semipermanently used. Besides, the gap adjustment section is not always driven, and can be semipermanently used. Thus, the charging roller and the gap adjustment section are separated from the photoreceptor detached at a specified period and can be placed in the image forming apparatus body.

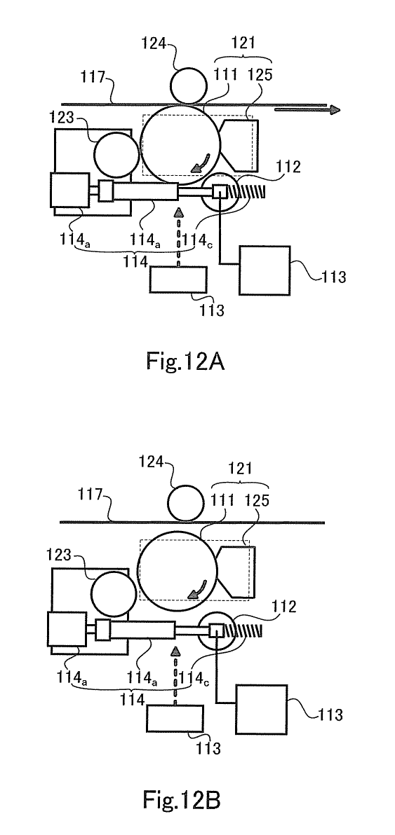

For example, as shown in FIG. 12A, a photoreceptor 111 and a photoreceptor cleaner 125 are formed into an integral process unit 121 and are placed below a transfer roller 124 and a transfer belt 117. A developing device 123, an exposure device 126, a charging roller 112, a power source 113, and a gap adjustment section 114 including a micrometer 114a, a motor 114b and a spring 114c are placed therebelow.

When the process unit 121 is detached, as shown in FIG. 12B, the upper transfer roller 124 and the transfer belt 117 are separated upward. After the process unit 121 is slid upward, it is pulled out to this side and can be extracted from the image forming apparatus body.

In the embodiment, although the photoreceptor 121 and the photoreceptor cleaner 125 are formed into the integral process unit 121 which can be detached, the developing device 123, a charging roller cleaner (not shown) such as a sponge roller, or the like may be placed on the process unit side.

While certain embodiments have been described, these embodiments have been presented by way of example only, and are not intended to limit the scope of the inventions. Indeed, the novel embodiments described herein may be embodied in a variety of other forms; furthermore, various omission, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image forming apparatus comprising:
an image carrier;
a charging section configured to charge the image carrier and to provide a gap between the charging member and the image carrier;
a power source configured to apply a voltage to the charging member;
a measuring section configured to measure a voltage or a current between the image carrier and the charging member; and
a gap adjustment section configured to adjust the gap between the image carrier and the charging member based on a measurement result of the voltage or the current.

2. The apparatus according to claim 1, wherein the gap adjustment section independently adjusts the gap at one end and the gap at the other end of the charging member in a longitudinal direction.

3. The apparatus according to claim 1, wherein the charging member has a roller shape.

4. The apparatus according to claim 2, wherein the charging member is an elastic roller.

5. The apparatus according to claim 2, wherein hardness of the charging member is 50° or more.

6. The apparatus according to claim 1, wherein diameters of both ends of the charging member are larger than a diameter of a center part.

7. The apparatus according to claim 1, wherein the gap adjustment section includes:
an elastic body configured to press the charging member to the image carrier side; and
a movement control section configured to move the charging member in a direction of separating from the image carrier and to control the gap.

8. The apparatus according to claim 1, wherein the charging member and the gap adjustment section are fixed to a body of the image forming apparatus.

9. The apparatus according to claim 8, wherein the image carrier can be separated and detached from the body of the image forming apparatus.

10. An image forming method comprising:
measuring a voltage or a current by applying a voltage between a charging member and a image carrier, the charging member to charge an image carrier and to be arranged to provide a gap between the charging member and the image carrier;
adjusting the gap between the image carrier and the charging member based on a measurement result of the voltage or the current;
charging the image carrier by the charging member;
exposing the image carrier to form an electrostatic latent image;
developing the electrostatic latent image to form an image on the image carrier; and
transferring the image to a transfer medium.

11. The method according to claim 10, wherein the charging member has a roller shape.

12. The method according to claim 10, wherein after the image carrier and the charging member are brought into contact with each other, they are separated to adjust the gap.

13. The method according to claim 12, wherein the charging member is an elastic roller.

14. The method according to claim 13, wherein hardness of the charging member is 50° or more.

15. The method according to claim 12, wherein the image carrier and both ends of the charging member are brought into contact with each other.

16. The method according to claim 12, wherein the charging member is pressed by an elastic body and is brought into contact.

17. The method according to claim 12, wherein after one end of the charging member in a longitudinal direction is separated until the measurement value becomes a specified value, the other end is separated until the measurement value becomes the specified value and the gap is adjusted.

18. The method according to claim 10, wherein the charging member is moved in a direction of separating from the image carrier, and the gap between the image carrier and the charging member is adjusted.
